(19) United States
(12) Patent Application Publication
(10) Pub. No.: US 2013/0252715 A1
(43) Pub. Date: Sep. 26, 2013

(54) GAMING SYSTEM

(71) Applicant: FIVE1EIGHT INTERNET MEDIA LLC, Delmar, NY (US)

(72) Inventors: Todd James Drowlette, Glenmont, NY (US); Patrick Shaun Gray, Delmar, NY (US); Eric Peter Heidelmark, Plainville, CT (US)

(73) Assignee: Five1Eight Internet Media LLC, Delmar, NY (US)

(21) Appl. No.: 13/849,774

(22) Filed: Mar. 25, 2013

Related U.S. Application Data
(60) Provisional application No. 61/615,426, filed on Mar. 26, 2012.

(51) Int. Cl. G07F 17/32

(52) U.S. Cl. CPC G07F 17/3288
USPC 463/25

(57) ABSTRACT

Various aspects of the invention include a gaming system which allows players to place wagers on events. In some particular aspects, gaming systems and methods are disclosed which allow players to wager points (or, chips, in specific situations) having non-monetary value on the outcome of events, e.g., sporting events. In some cases, a user receives an initial point value for initiating the system, and can accumulate additional points in response to winning one or more wagers with one or more additional users. These points (or, chips) may be used to acquire prizes. Additionally, the gaming system allows users to purchase (using monetary value) in-system currency which can be used to alter the parameters of a given event or wager.

### CROSS-REFERENCE TO RELATED APPLICATIONS

This application claims priority to U.S. provisional application No. 61/615,426, filed on Mar. 26, 2012, which is incorporated by reference herein in its entirety.

### FIELD OF THE INVENTION

The subject matter disclosed herein relates to gaming. More specifically, the subject matter disclosed herein relates to gaming systems and related methods.

### BACKGROUND

Wagering on sports is a leisure pastime that has been enjoyed all over the world for centuries. The advent of the internet changed the face of the sports betting industry by providing access to new players worldwide and enabling a far more varied portfolio of wagering products to be offered. However, current wagering mechanisms are still deficient in a number of respects.

### BRIEF SUMMARY OF THE INVENTION

Various aspects of the invention include a gaming system which allows players to place wagers on events. In some particular aspects, gaming systems and methods are disclosed which allow players to wager points (or, chips, in specific situations) having non-monetary value on the outcome of events, e.g., sporting events. In some cases, a user receives an initial point value for initiating the system, and can accumulate additional points in response to winning one or more wagers with one or more additional users. These points (or, chips) may be used to acquire prizes. Additionally, the gaming system allows users to purchase (using monetary value) in-system currency which can be used to alter the parameters of a given event or wager.

Various embodiments include a gaming system including: at least one computing device configured to perform the following: permit users to register for a wagering account; provide the registered users with credits in response to the registering; allow the registered users to wager on events; and allow users to modify a parameter of the event using accumulated parameter-modifying currency.

Various additional embodiments include a gaming system having: at least one computing device configured to perform the following: permit a user to register for a wagering account; provide the registered user with at least one credit in response to the registering; permit the user to register for a wagering tournament including a plurality of events; allow the registered user to wager on an event in the plurality of events, the user competing against at least one other user in the wagering tournament; and allow the user to modify a parameter of the event in the plurality of events using accumulated parameter-modifying currency.

Various other embodiments include a gaming system having: at least one computing device configured to perform the following: permit a user to register for a wagering account; provide the registered user with at least one credit in response to the registering; permit the user to register for a wagering tournament including a plurality of successively occurring sporting events; allow the registered user to wager on a sporting event in the plurality of successively occurring sporting events, the user competing against at least one other user in the wagering tournament; and allow the user to modify a predetermined odds-based prediction of an outcome of the sporting event in the plurality of successively occurring sporting events using accumulated parameter-modifying currency.

### BRIEF DESCRIPTION OF THE DRAWINGS

FIGS. 1-3 illustrate tables according to various embodiments.

FIG. 4 illustrates a screen shot of an example home page of a website according to various embodiments.

FIG. 5 illustrates a screen shot of an example welcome back page of a website according to various embodiments.

FIG. 6 illustrates a screen shot of an example account summary page of a website according to various embodiments.

FIG. 7 illustrates a screen shot of an example user profile page of a website according to various embodiments.

FIG. 8 illustrates a screen shot of an example wagering portal page of a website according to various embodiments.

FIG. 9 illustrates a screen shot of an example scoreboard page of a website according to various embodiments.

FIG. 10 illustrates a screen shot of an example leaderboard page of a website according to various embodiments.

FIG. 11 illustrates a screen shot of an example “cage” page according to various embodiments.

FIG. 12 illustrates an example environment according to various embodiments.

FIG. 13 shows an illustrative home page of the gaming system website according to various embodiments.

FIG. 14 shows an illustrative “welcome back” page according to various embodiments.

FIG. 15 shows an illustrative account summary page according to various embodiments.

FIG. 16 shows an illustrative user profile page according to various embodiments.

FIG. 17 shows an illustrative “picks” page according to various embodiments.

FIG. 18 shows an illustrative scores page according to various embodiments.

FIG. 19 shows an illustrative leaderboard page according to various embodiments.

FIG. 20 shows an illustrative “cage” page according to various embodiments.

FIG. 21 shows an illustrative tournament signup page according to various embodiments.

FIG. 22 shows an additional example environment according to various embodiments.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION

As noted herein, the subject matter disclosed relates to gaming. More specifically, the subject matter disclosed herein relates to gaming systems and related methods.

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

Various embodiments include a gaming system having: at least one computing device configured to perform the following: permit users to register for a wagering account; provide the registered users with credits in response to the registering; allow the registered users to wager on events; and allow users to modify a parameter of the event using accumulated parameter-modifying currency.

Various additional embodiments include a gaming system having: at least one computing device configured to perform the following: permit a user to register for a wagering account; provide the registered user with at least one credit in response to the registering; permit the user to register for a wagering tournament including a plurality of events; allow the registered user to wager on an event in the plurality of events, the user competing against at least one other user in the wagering tournament; and allow the user to modify a parameter of the event in the plurality of events using accumulated parameter-modifying currency.

Various other embodiments include a gaming system having: at least one computing device configured to perform the following: permit a user to register for a wagering account; provide the registered user with at least one credit in response to the registering; permit the user to register for a wagering tournament including a plurality of successively occurring sporting events; allow the registered user to wager on a sporting event in the plurality of successively occurring sporting events, the user competing against at least one other user in the wagering tournament; and allow the user to modify a predetermined odds-based prediction of an outcome of the sporting event in the plurality of successively occurring sporting events using accumulated parameter-modifying currency.

The gaming system (also referred to as, BetBomb.com or Bet Bomb) is configured to perform processes described herein according to various embodiments. The gaming system allows players to make selections (or, picks) against real spreads, lines and totals for all major league sports and some college sports. These sports can include, e.g., professional baseball, professional football, professional hockey, professional basketball, as well as college football and college basketball. The gaming system can be offered without charge to players, and the gaming system can allow users to compete for prizes like tablet or other computing devices, MP3 players, televisions (e.g., three-dimensional (3D) TVs), etc.

The gaming system allows users to socialize, win prizes, and share their passion for sports and competition by utilizing their skill in picking winners in a tournament-style setting. The tournament-style features of the gaming system are described further herein.

The gaming system can be offered as free (no charge) website that allows users to place daily bets and keep statistics on how they are performing in one or more competitions. The gaming system can provide users with the ability to join tournaments to win real (physical) prizes at no cost. To give users a slight edge over their competition the gaming system allows the users to buy “bomb bucks” to change parameters of an event (e.g., move lines in sporting events) to increase their percentage of winning. These “bomb bucks” can be considered upgrades, and can be bought in various package bundles.

The gaming system can include an online sports wagering site that improves on the conventional gaming systems. The gaming system (e.g., including website) uses innovative technology to make betting easy along with bringing a social aspect to sports betting while being free of charge.

The gaming system can function similarly to traditional sports wagering websites, but in contrast to the conventional wagering websites, users will not wager real money (hard currency). The users can use website-specific points (or simply, points) to wager on games to win additional website-specific points. Accumulated points can then be used to buy into tournaments where the user has an opportunity win prizes. Users can compete in weekly, bi-weekly, monthly and seasonal tournaments. The user who accumulates the most points in a given year will also be the “BetBomb.com champion” who can win a grand prize.

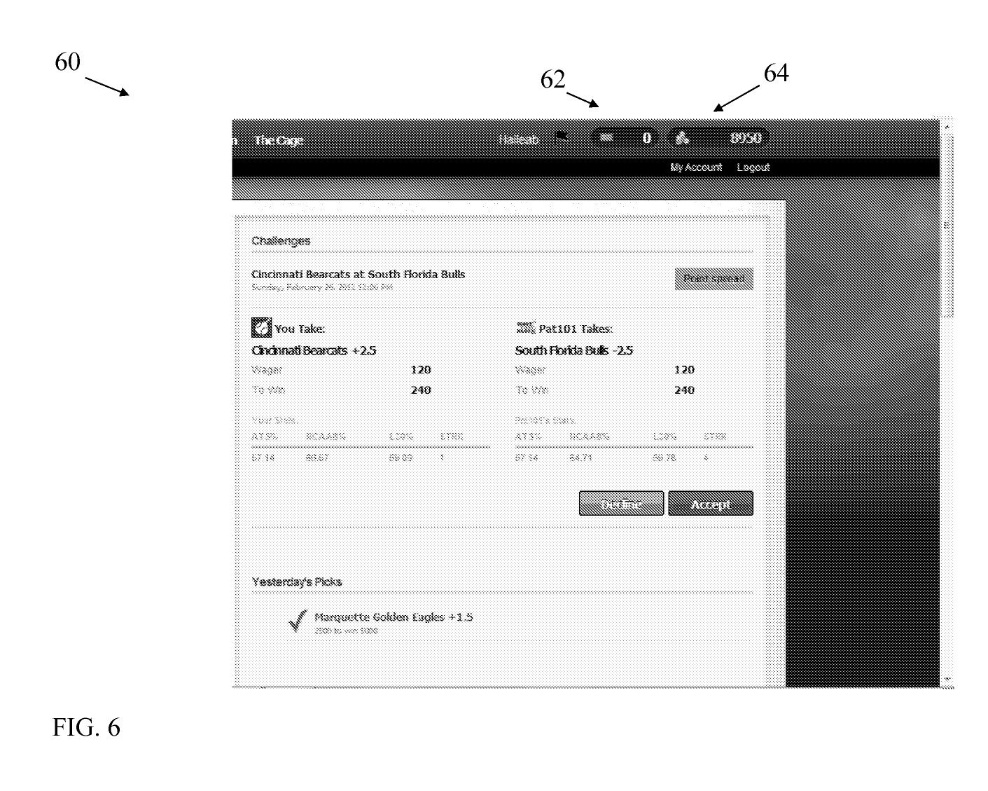

At initial registration, a user receives X points (e.g., 1000 points) and an additional Y points (e.g., 100 points) every time the user logs in. Users can also be given points for referring other users to the website. Users can attempt to pick the winner of a particular sporting event based on the set point spread or money line. In some cases, the user makes picks based on the user's knowledge of the sport and any research the player performed on the team or its players. To help increase the user's odd of picking the correct winner, a user can purchase upgrades via the gaming system' “bomb-bucks” (or, bucks), and those bucks can be used to adjust the line (or spread) in a direction that the user believes will be more favorable to picking the winning team. As used herein, the terms “bomb-bucks” or “bucks” is substantially synonymous with a line or spread-altering currency. That is, these terms can refer to currency used to alter a line or spread in an event. This line or spread-altering currency can be separate from the points earned by a user and described according to various embodiments. The points and the line or spread-altering currency can be kept in a separate account within the gaming system. These points and the currency can be displayed in separate categories via the website (e.g., categories 62 and 64 in the displayed webpage 60 of FIG. 6).

In some cases, the user is limited in moving the line/spread, e.g., a 9 game point limit can be set for moving the line/spread. This limit can be established based upon the sporting event and/or the original line/spread, and can be established regardless of the amount of bucks (line/spread altering currency) the user has available. In some cases, this limit could be based upon the type of sport, e.g., traditionally higher scoring sports (e.g., professional basketball) may have distinct game point limits from traditionally lower scoring sports (e.g., professional hockey).

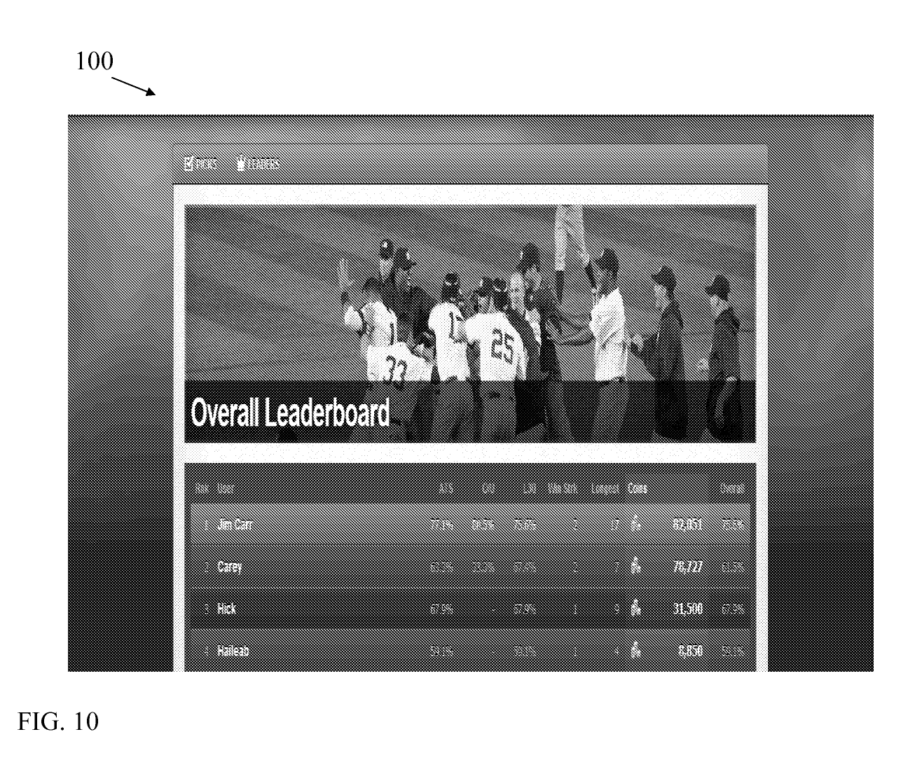

Users can have the ability to keep track of all of the wagers that they make across all sports. Users can also keep track of all current tournament leaders via the site Leader Boards (see, e.g., FIG. 10). Site points can be used to purchase playing “chips” (or tokens) for a given tournament. In each tournament, the user that ends with the most “chips” wins the tournament. If the user wins the tournament, the user can be awarded the designated prize for that tournament.

There are at least two distinct types of tournaments that a user can enter. The first type of tournament is an open tournament where the entry fee is equivalent to a certain amount of points. A user can use points accumulated prior to the start of the tournament to enter the tournament.

The second type of tournament can include an invitational tournament where a top percentage (e.g., top 1 percent, top 5 percent, top 10 percent) of the website's sports pickers can be selected to enter at no cost/point amount. Players can still use bomb-bucks in either tournament format to help give them a statistical edge (e.g., to adjust the line/spread). In the second tournament type, there will be no purchase necessary (no points required), and an equal chance for holders and non-holders of bomb-bucks to win the second type of tournament.

Users will also be able to challenge their friends registered with the gaming system (e.g., via the website) by issuing personal wagers on games. This will provide another method for users to accumulate points as well as bring a social aspect to the experience of using the gaming system.

The following terminology may be helpful in understanding how to wager on games and compete in tournaments using the gaming system:

Points: Points will be wagered to enter games instead of real money (e.g., currency such as dollars, euros, etc.). For example, a user will wager 100 points on a game to win 100 points. Users will receive an initial point amount (e.g., 1000 points) when they sign-up for the gaming system (e.g., via the website), and an additional point amount (e.g., 100 points) smaller than the initial point amount, every time they log into the gaming system. Users can also be given points for referring friends (e.g., 500 points).

Bomb-Bucks: Bomb-Bucks are the official site currency of the gaming system's website and are used to perform upgraded functionality on the site. Users can purchase Bomb-Bucks with real money (e.g., dollars, euros, etc.) via a credit card transaction or they can request free Bomb-Bucks by mailing in promotional codes provided by the gaming system (e.g., its website). Free Bomb-Bucks can be limited to one per mailed in promotional request. However, there may be no limit on the number of requests a user can mail-in. Users can spend Bomb-Bucks on various things around the site including:

Purchasing betting trends on games. This includes user consensus which is the percentage of people betting in either direction including the over/under. This also includes wagering trends which a user can see past consistencies to help predict future outcomes.

Purchasing gaming system (e.g., website) merchandise. This can include t-shirts, key chains, wrist bands, etc.

Purchasing information on detailed weather conditions in the area of the sporting event. For example a user can find out whether it is raining, snowing or sunny at a sporting event, which can help the user make an educated guess regarding the outcome of the game.

Bomb-Bucks can be used to move the already established point spreads on games in either direction.

Bomb-Bucks can also be used to customize a user's profile. This includes profile picture, design, layout, etc.

Chips: Chips are “points” specific to tournaments. Similarly to entering a poker tournament and playing for chips instead of cash, users will play for chips instead of site points. Users will use site points to enter a tournament where the user will be awarded a certain amount of chips. For example, a user may buy into a 2,000 points tournament where each users starts with 5,000 chips.

The Cage: The Cage is the section of the website where users can purchase Bomb-Bucks.

Leaderboards: This is the section of the website that displays the leaders in tournaments and overall sports betting statistics.

### Tournaments and Prizes

The gaming system can hold weekly, bi-weekly, and/or monthly play-offs, and seasonal tournaments for each of the leagues featured on the site. The prize price values can increase as the frequency of the tournament decreases. For example, prizes for bi-weekly tournaments can have a smaller price value than prizes for monthly tournaments. The prizes can include, but are not limited to, the following: TVs, personal music players, cellular phones, smart phones, video cameras, digital cameras, tablet PCs, netbooks and/or mini netbooks, laptops/computers and/or gift cards.

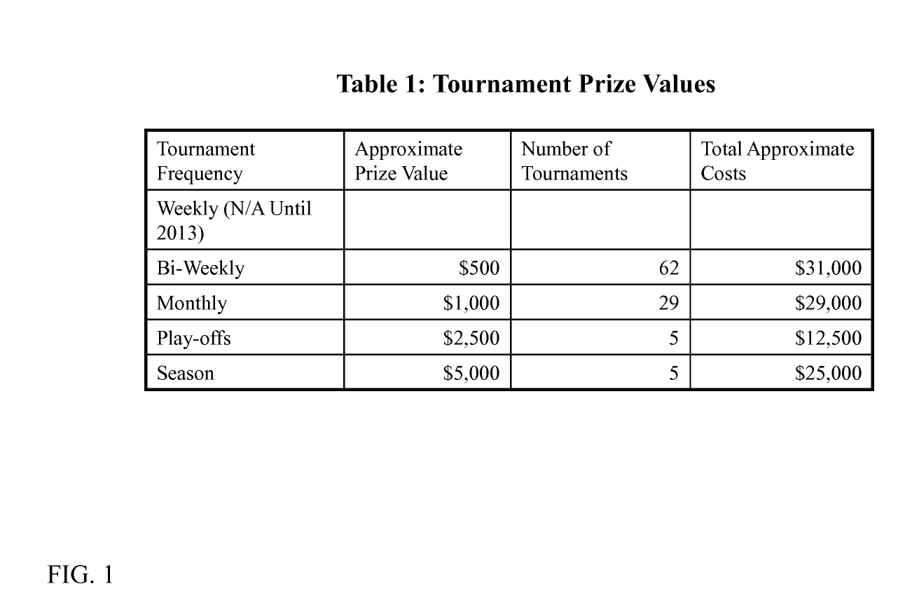

FIG. 1 shows an example tournament prize value table, illustrating the principal that prize values can be higher for less frequently held tournaments.

The example totals were calculated based on the following assumptions:

62 bi-weekly tournaments;

29 monthly tournaments;

5 league play-off tournaments; and

5 league season tournaments

In various particular embodiments, the gaming system can provide one or more tournaments to the users that combine poker-style tournament configuration with strategic sports wagering. In some cases, the poker-style tournament has a similar format to known holdem (or, “hold-'em”) card tournaments. In these cases, users (e.g., players) enter (e.g., buy into) the tournament with a fixed number of chips, which represent each user's stake in the game. The users compete against one another through wagering on a series of events (e.g., sporting events), and the player(s) with the most (or greater than a threshold number of) chips at the conclusion of the tournament can be considered the winning user, and provided with a prize.

In various embodiments, the gaming system provides the user with the entry chips, making entry essentially free. In other cases, the user must buy-in to the tournament using site points accumulated over time. After entering the tournament, regardless of the amount of points required for entry, each user receives chips (e.g., 5,000 chips) for wagering during the tournament. Each event (e.g., in a series of sequential events) may require a certain number of chips to enter. In various embodiments, a tournament can span a period of time, e.g., one or more days, one or more weeks, one or more months, etc. In various embodiments, a user can wager on one or more events (e.g., sporting events) during the duration of a tournament.

In various embodiments, the gaming system can provide a leaderboard with periodic (e.g., daily, weekly, hourly, etc.) updates showing which user(s) are leading the tournament. In some cases, the gaming system provides a display with tabs, e.g., a prizes tab, rules tab, message board tab, past picks (or, selections) tab and/or a groups tab. Within the groups tab, the user can create a private or public group and/or host his/her own tournament. Groups may also compete in a larger overall tournament.

As a tournament progresses, users have the option to wager one or more chips, based upon the wager(s) made by other users against which the user is competing. In some cases, when a user loses all of his/her chips, that user is removed from the tournament. In some particular cases, however, the user may be given the option to buy back into the tournament using points, bomb bucks or other chips. In some particular cases, tournaments will have an “anti”, which requires a user to wager on an event or lose one or more chips. In some cases, the “anti” is calculated based upon a number of events in the tournament and an initial chip value, such that the total of all anti values across the series of events is equal to the initial chip value. This will prevent a user from being able to simply not bet as a mechanism for advancing to win the tournament. As in a poker tournament, some tournaments provided by the gaming system will allow a user to go “all-in” and wager all of his/her remaining chips on an event and challenge the other participating users to go “all-in” as well. As in other competitions, including tournaments, described herein, the gaming system allows a user to modify the line (e.g., point spread) on an event (e.g., game) using Bomb-Bucks.

### Upgrades

Users will be able to purchase upgrades with real money (e.g., dollars, euros, etc.), e.g., via a credit card transaction. The upgrade can be delivered in the form of a Bomb-Buck. With the Bomb-Buck, the user can perform various additional functions on the website, as described herein. At least one benefit of the upgrade will be the user's ability to change established point spread(s) on games.

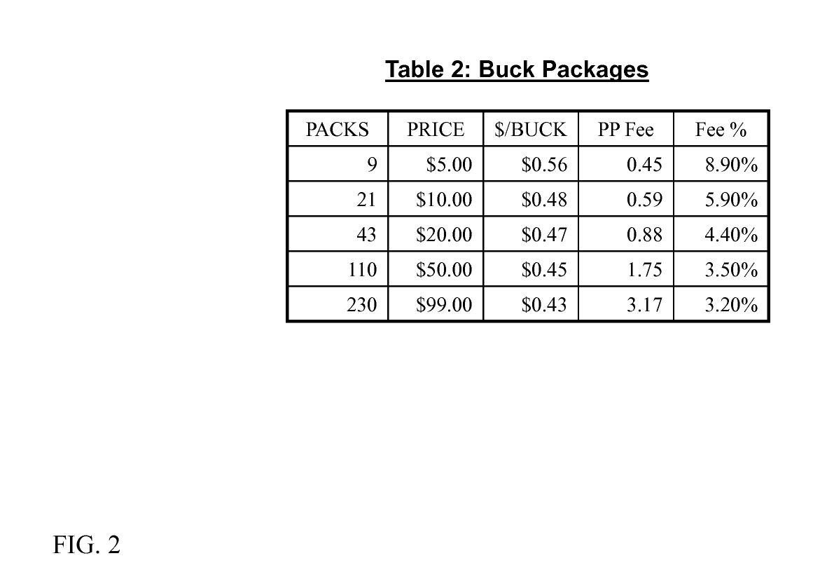

Bomb-Bucks can be sold, e.g., in packs of 9, 21, 43, 110, and 230. The below table provides an example breakdown of Bomb-Bucks costs for a user in one illustrative scenario. Table 2 (FIG. 2) shows illustrative examples of buck packages according to some embodiments.

### Moving Lines

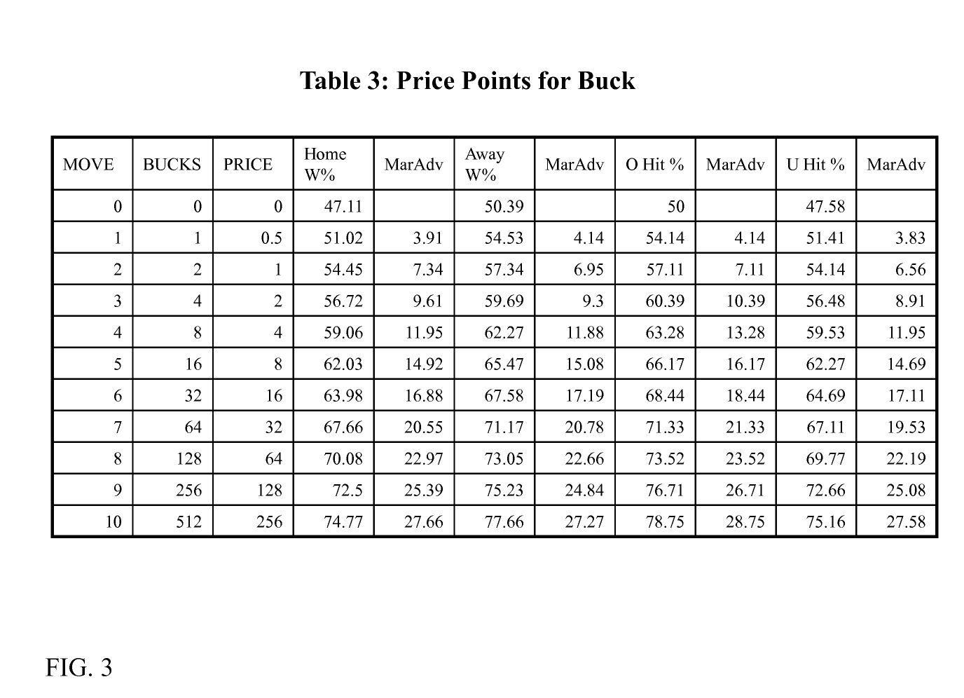

As mentioned herein, one benefit of purchasing upgrades is to provide the user with the ability to change already established point spreads (or lines) on games. Moving the spread/line will help increase the user's advantage of winning in the respective tournament. However, moving the line/spread doesn't guarantee that the user will win the tournament. As shown in FIG. 3 (Table 3: Price Points for Buck(s)), the user's advantage increases the more line is moved away from the established point spread.

### Site Design

The gaming system website was designed and developed into eight main components. Ease of use and the likeability of the typical online sports wager were paramount in coming up with the overall design of the site. The eight components of the site are as follows:

Gaming system website (BetBomb.com) home page;

Welcome back page for existing users. This page gives users a brief summary of their account and provides news of recent site changes and updates;

Account summary page. This page provides user with a more detailed summary of their site activity;

User Profile Page. This is the user's public profile page that is seen by other site users. It provides a view into the user stats and also provides a public message board where other users can post messages;

Gaming System (BetBomb.com) SportsBook. This is the page where users will place their wagers and enter into tournaments;

Scores. This page provides the latest scores for each league;

The Leaderboard. The page provides leader board ranking and betting statistics for the site betting leaders;

The Cage. The cage is similar to the cashier on traditional online sports wagering sites. Users can purchase upgrades via Bomb-Bucks in the cage.

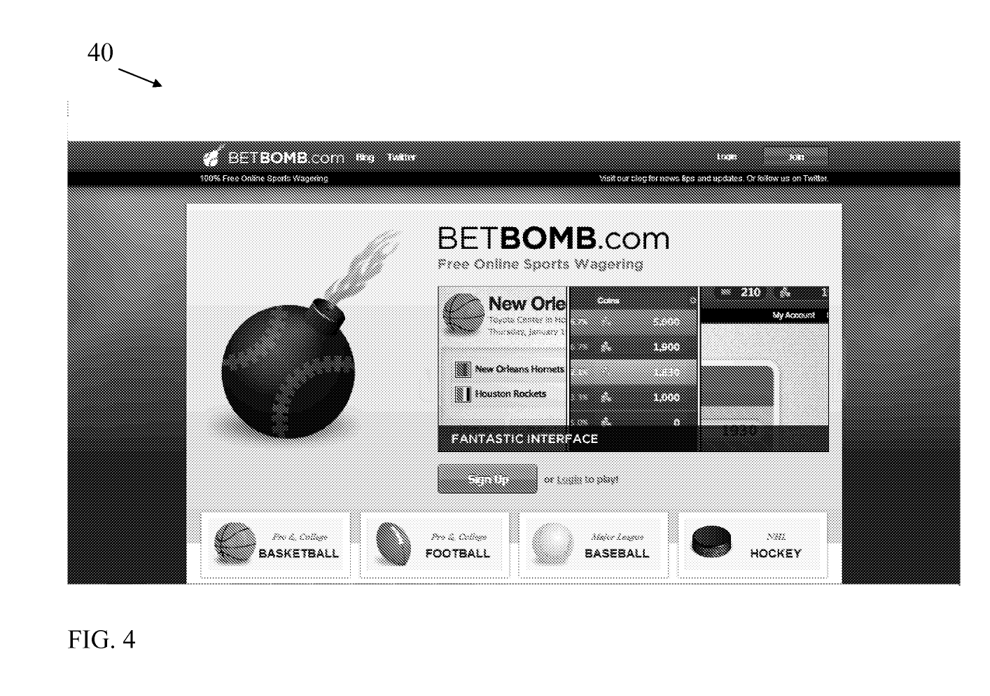

FIGS. 4-11 illustrate example screen shots according to various embodiments of the invention.

FIG. 4 shows an example screen shot of a home page 40 of the gaming system website.

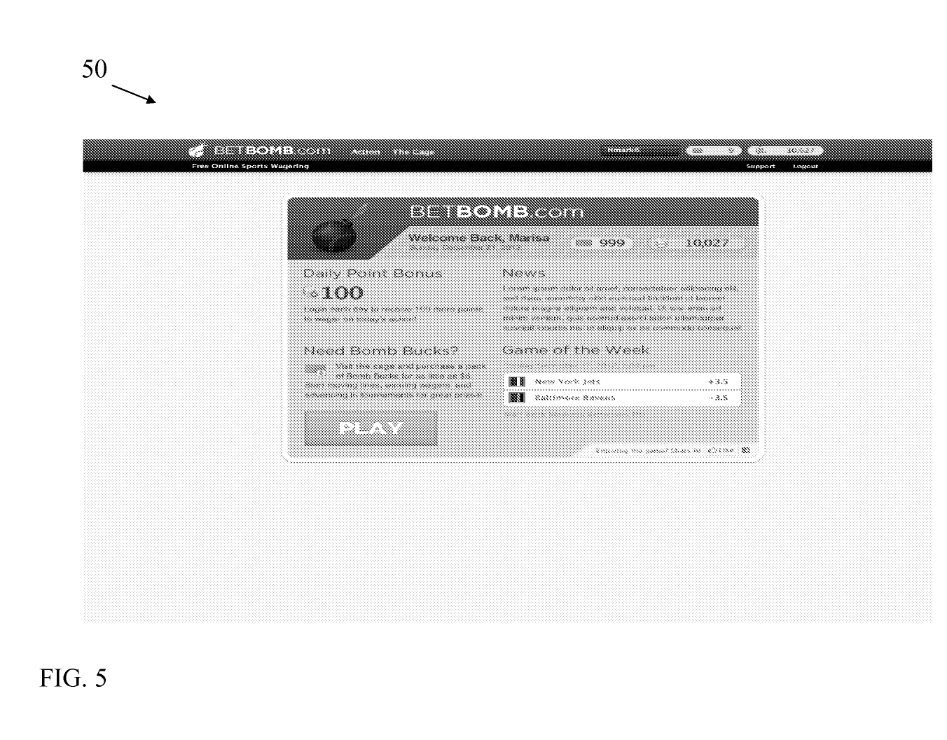

FIG. 5 shows an example screen shot of a personal account login page 50 of the gaming system website, showing a daily point bonus amount, as well as a bomb bucks balance and point balance.

FIG. 6 shows an example screen shot of a challenge page 60 of the gaming system website.

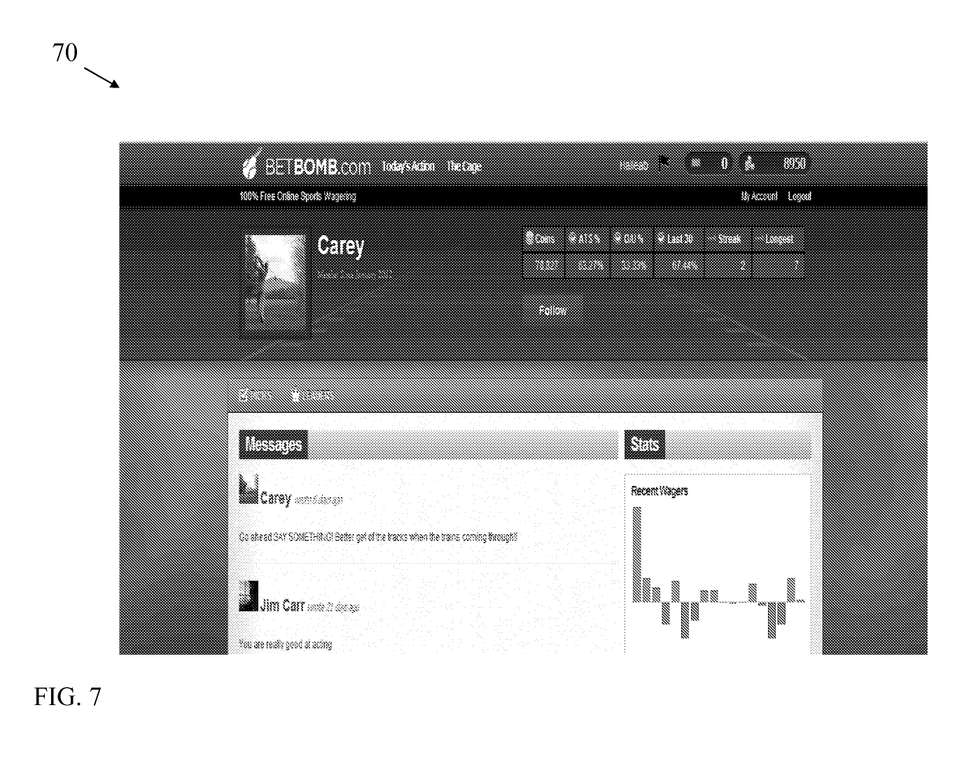

FIG. 7 shows an example screen shot of a message page 70 of the gaming system website.

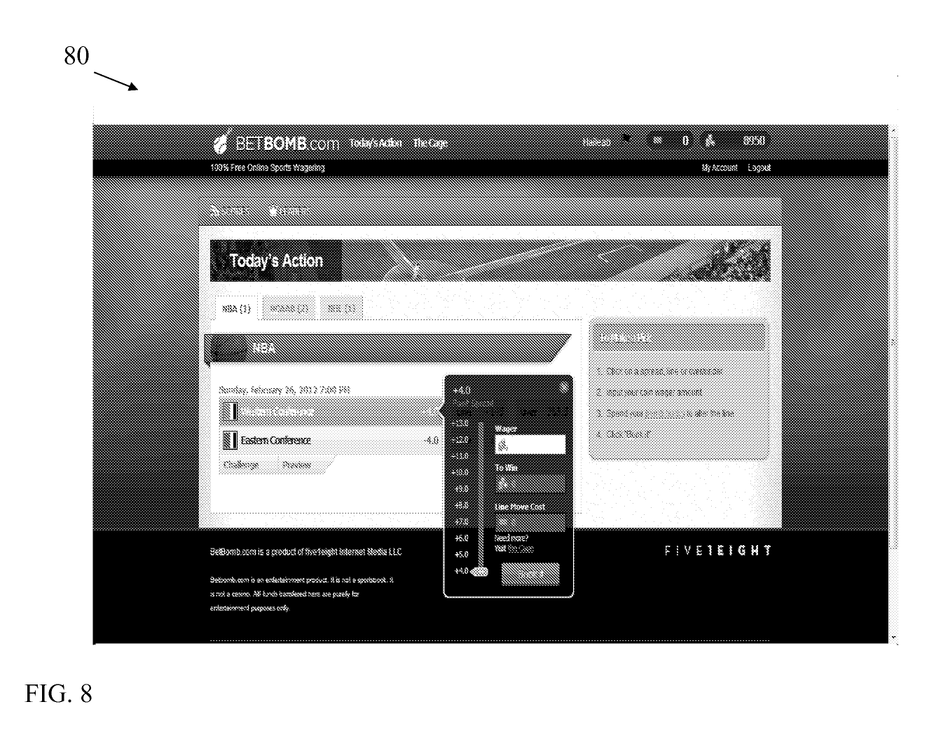

FIG. 8 shows an example screen shot of a sports book page 80 of the gaming system website.

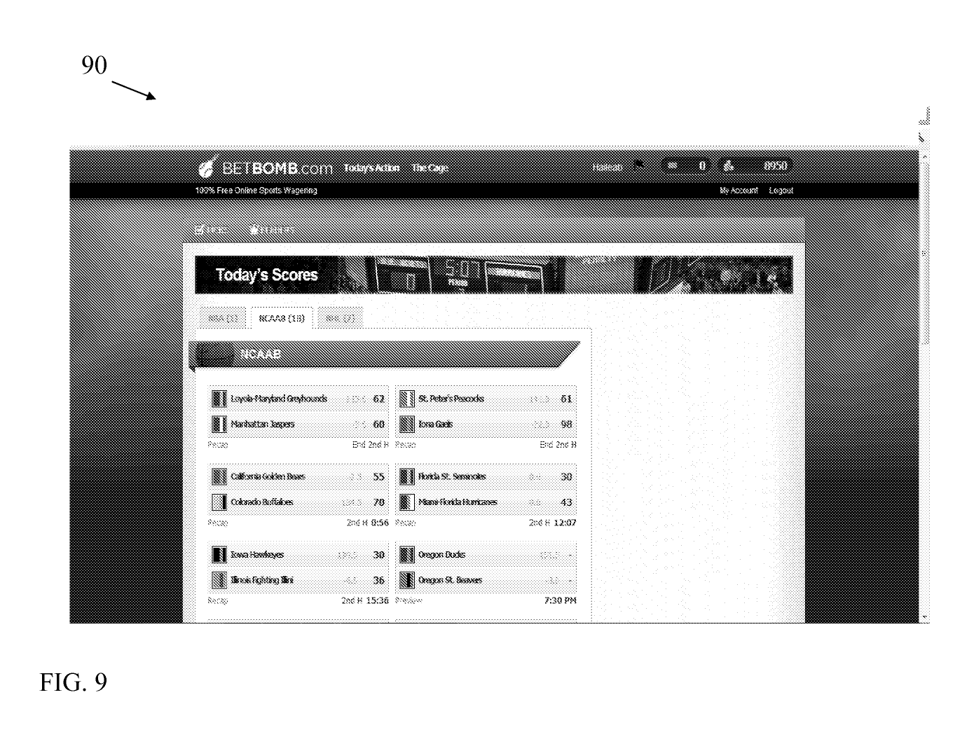

FIG. 9 shows an example scoreboard page 90 of the gaming system website.

FIG. 10 shows an example leaderboard page 100 of the gaming system website.

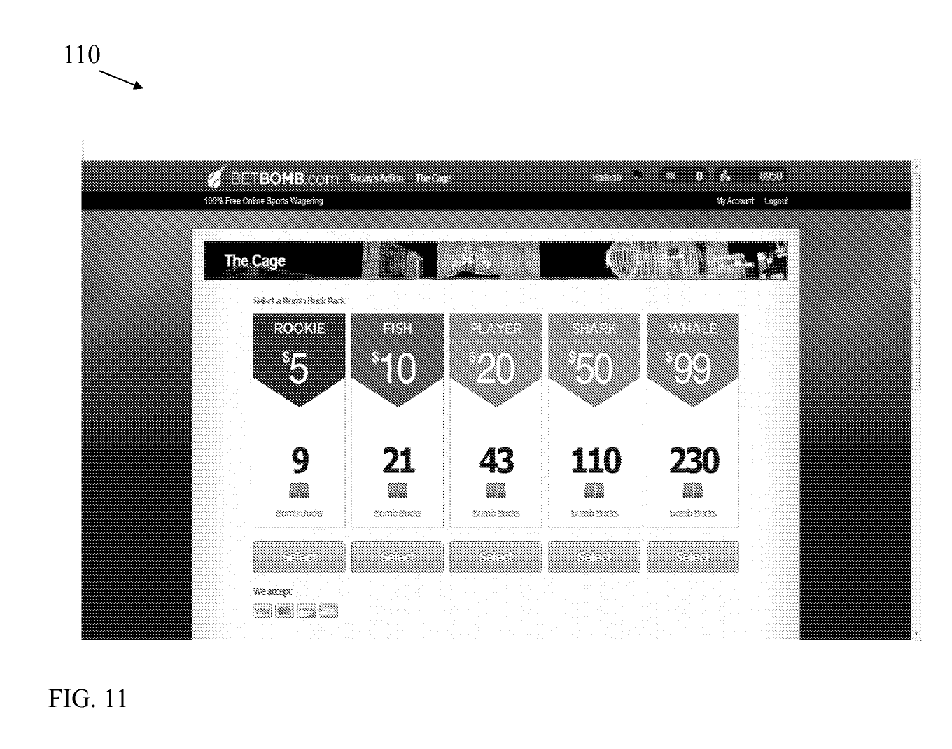

FIG. 11 shows an example of The Cage page 110 of the gaming system website.

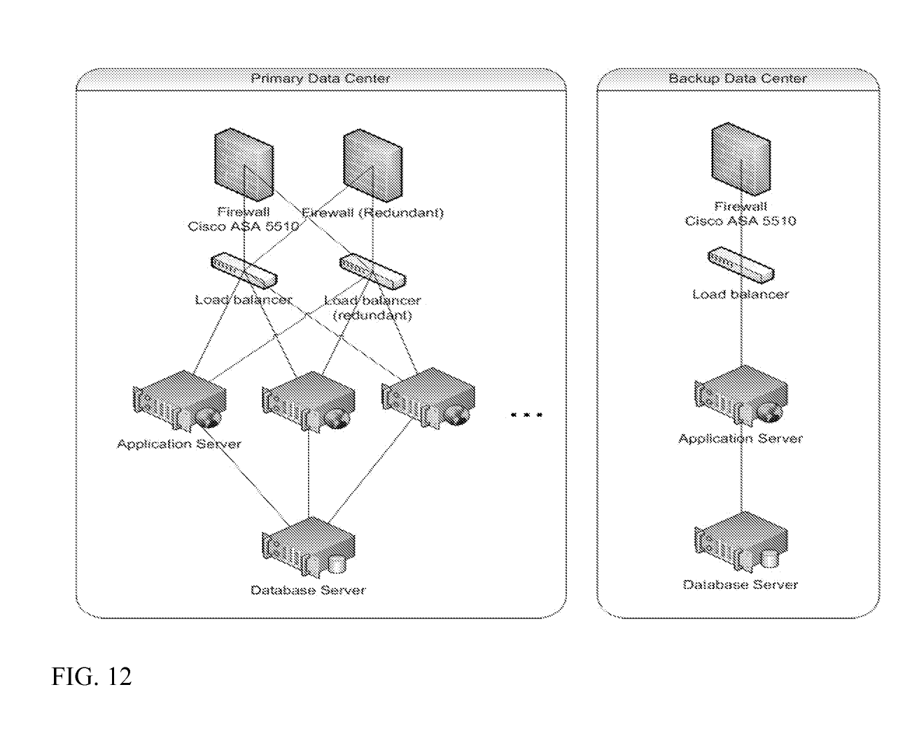

FIG. 12 illustrates an environment (technology design) which can help in implementing various embodiments of the gaming system.

### Sports Feed

One or more sports feeds can be used to supply the automatic odds feeds that will be used on the gaming system website (BetBomb.com). The odds feeds include odds set by public sports books for most sports and competitions. There are at least two classes of feeds:

Standard Feeds: Standard feeds only include odds for one sports book and are updated every 10 minutes.

Premium Feeds: Premium feeds contain odds for more than one sports book and are updated more frequently than standard feeds; premium feeds update every 5 minutes.

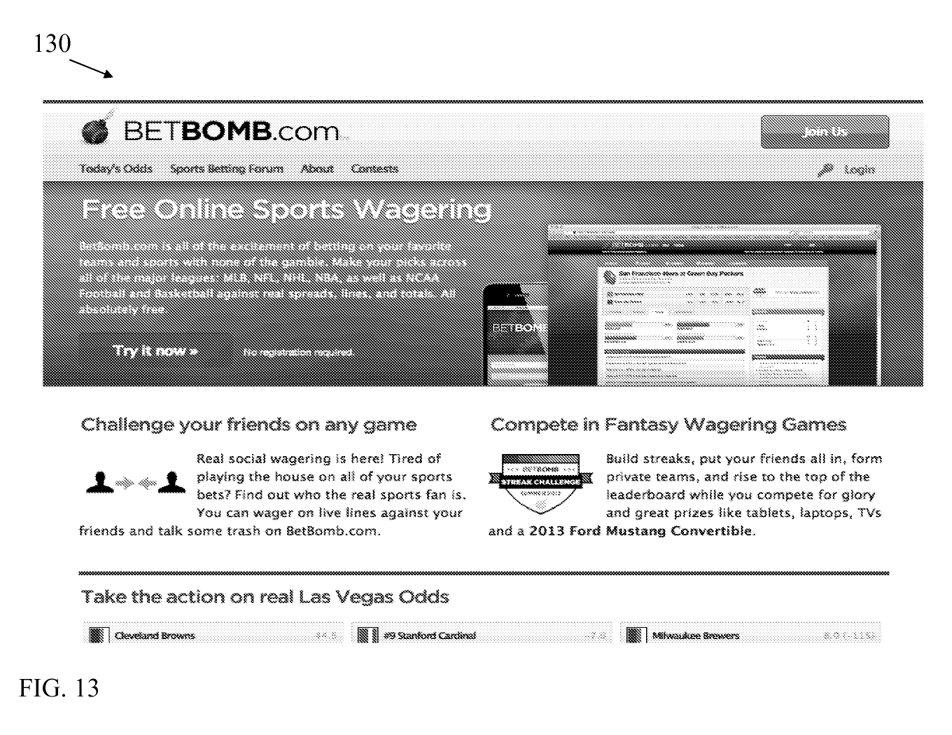

As described herein, various embodiments include a gaming (or wagering) system 126 (FIG. 13). In various embodiments, the gaming system 126 includes at least one computing device configured to perform the following:

A) permit users to register for a wagering account. As described herein, the gaming system 126 permits users to register for a wagering account via its website;

B) provide the registered users with credits in response to the registering. These credits are described herein as points, which can be accumulated by a number of methods described herein;

C) allow the registered users to wager on events. As noted herein, the users can wager on events such as sporting events, and can wager with respect to a winner, loser, total score, and/or margin of victory. As described herein, parameters such as the total score and/or margin of victory amounts can be modified in the wager according to various embodiments; and

D) allow user(s) to modify a parameter of the event using accumulated parameter-modifying currency. In these examples, the user(s) can modify a parameter (e.g., an odds-based parameter such as score and/or margin of victory) based upon a belief that the predetermined parameter does not represent a likely outcome of the event. In various embodiments, the user(s) can modify the parameter using a parameter-modifying currency. In various embodiments, the parameter-modifying currency can be purchased using real money (monetary value, e.g., dollars, euros, etc.). The parameter-modifying currency can be acquired by exchanging the real money via the wagering account.

In various embodiments, where the parameter of the event includes an odds-based parameter of the event, the modifying of the parameter of the event using the accumulated parameter-modifying currency increases a likelihood that the user will win a wager on the event.

In various embodiments, the event can include a sporting event, and the parameter can include an odds-based parameter. As noted herein, according to various embodiments, the credits do not correspond to a monetary value, that is, they are awarded or provided without a corresponding monetary charge to the user.

Various alternative embodiments include a gaming system including at least one computing device configured to perform the following:

I) permit a user to register for a wagering account;

II) provide the registered user with at least one credit in response to the registering;

III) permit the user to register for a wagering tournament including a plurality of events. As described herein, the wagering tournament can take one of at least two forms, and can allow the user to compete against other user(s) to accumulate chips and win prizes;

IV) allow the registered user to wager on an event in the plurality of events, the user competing against at least one other user in the wagering tournament; and

V) allow the user to modify a parameter of the event in the plurality of events using accumulated parameter-modifying currency. As noted herein, the parameter can include an odds-based parameter.

The at least one credit, in the tournament-style gaming system, does not correspond to a monetary value. However, as noted with respect to other example embodiments herein, the parameter-modifying currency does correspond to a monetary value, and the parameter-modifying currency is acquirable by exchanging the monetary value for the parameter-modifying currency via the wagering account. As noted herein, the process of modifying of the parameter of the event using the accumulated parameter-modifying currency increases a likelihood that the user will win a wager on the event against the at least one other user.

Various embodiments include additional processes, e.g., in response to the user registering for the wagering tournament, the at least one computing device further performs the following:

VI) provides the user with a set of chips for use in wagering on at least one event in the plurality of events;

VII) provides the user with at least one new chip in response to winning a wager on a first event in the plurality of events in the wagering tournament;

VIII) provides the user with at least one additional new chip in response to winning a subsequent wager on a second event in the plurality of events in the wagering tournament; and

IX) identifies the user as a winner of the wagering tournament in response to the user possessing more chips than all other users participating in the wagering tournament at a conclusion of the wagering tournament.

Various alternative embodiment include a gaming system having at least one computing device configured to perform the following:

i) permit a user to register for a wagering account;

ii) provide the registered user with at least one credit in response to the registering;

iii) permit the user to register for a wagering tournament including a plurality of successively occurring sporting events. The successively occurring sporting events can include events that occur one after the other, e.g., over the course of at least one day, at least one week, at least one month, etc.

iv) allow the registered user to wager on a sporting event in the plurality of successively occurring sporting events, the user competing against at least one other user in the wagering tournament; and

v) allow the user to modify a predetermined odds-based prediction of an outcome of the sporting event in the plurality of successively occurring sporting events using accumulated parameter-modifying currency. The predetermined odds-based prediction of the outcome of eth sporting event can include a predetermined spread (difference) in predicted scores for a first and second team, respectively, a total score of one or more teams, etc.

In various embodiments, the user is invited to register for the wagering tournament based upon performance by the user in wagering on previously occurring sporting events using the wagering account. In various other embodiments, the user is permitted to register for the wagering tournament in exchange for the user purchasing a right of entry to the wagering tournament.

FIG. 13 shows an illustrative home page 130 of the gaming system website according to various embodiments.

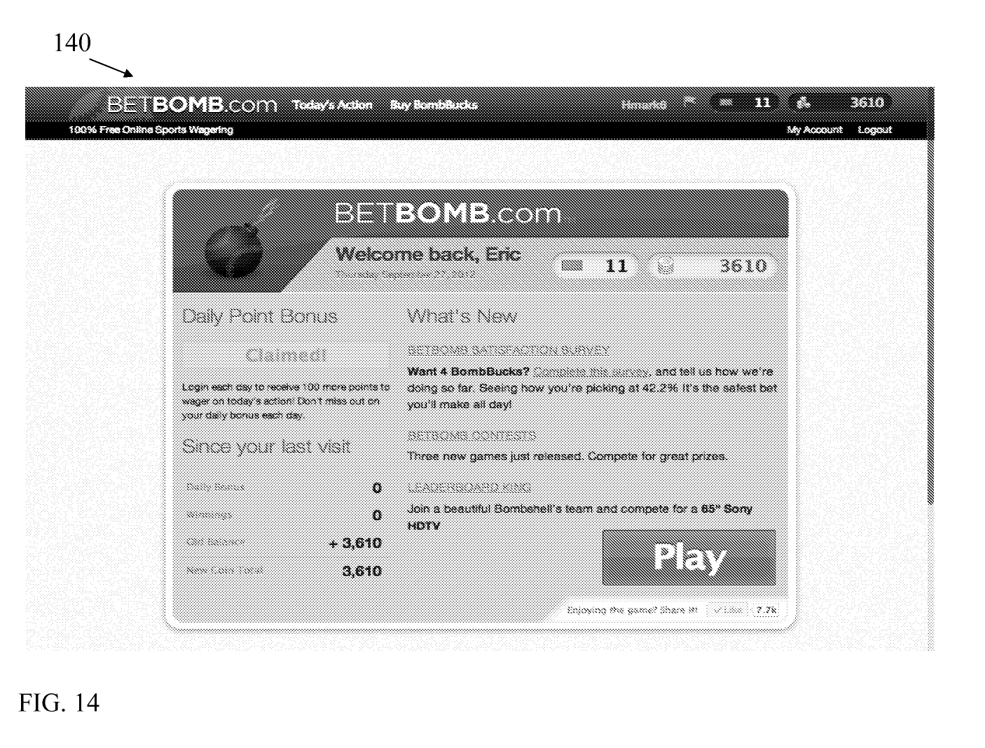

FIG. 14 shows an illustrative “welcome back” page 140 according to various embodiments.

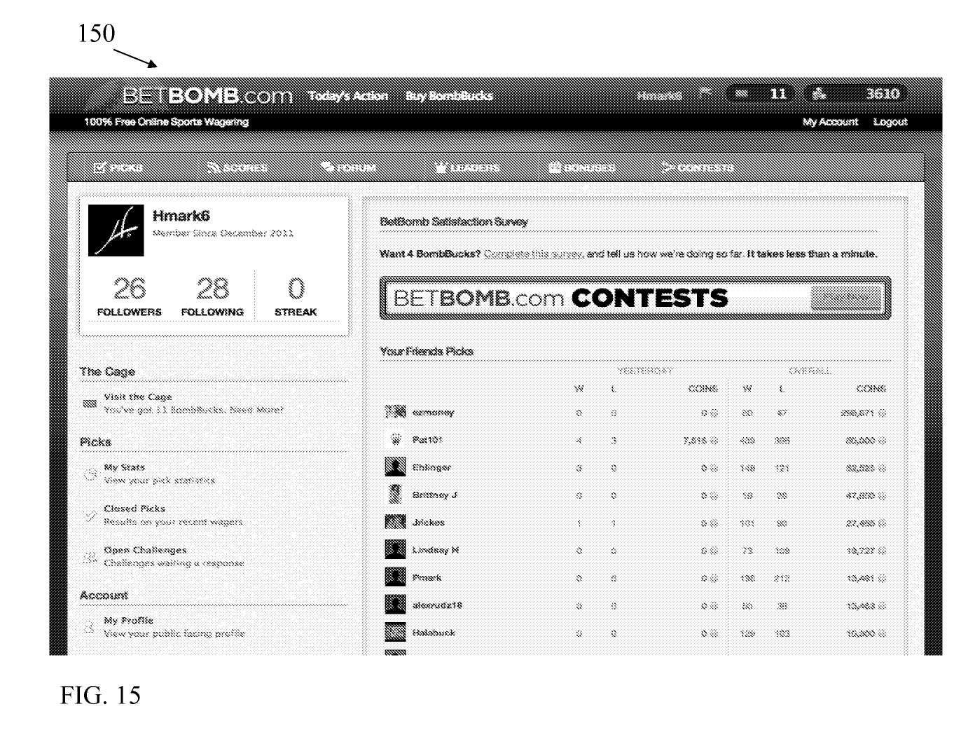

FIG. 15 shows an illustrative account summary page 150 according to various embodiments.

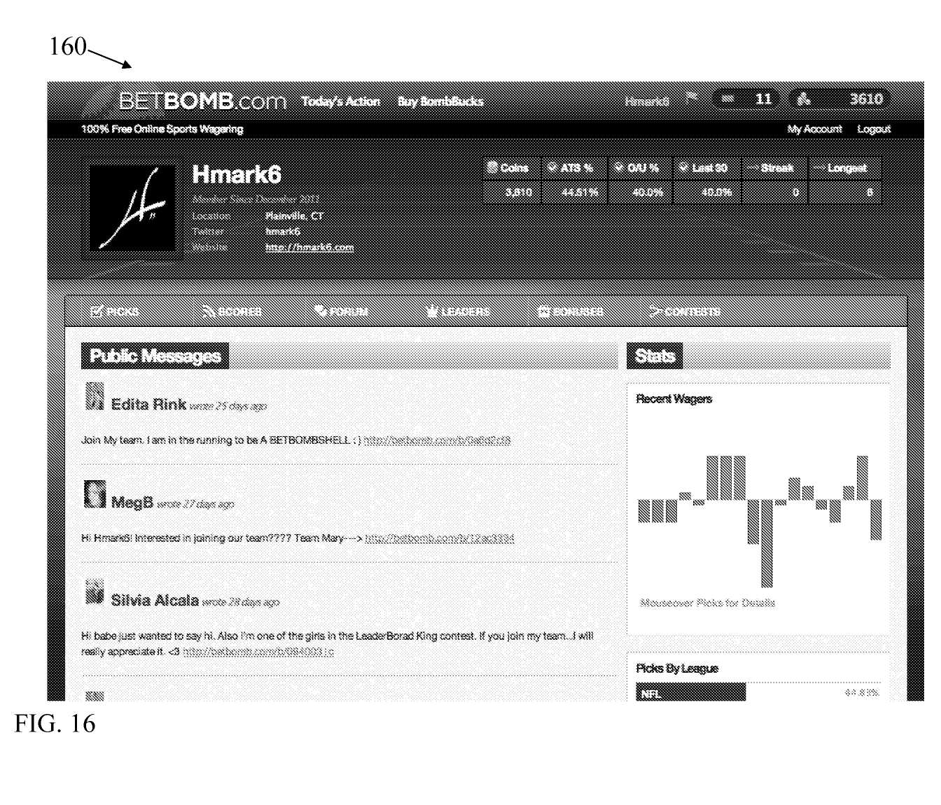

FIG. 16 shows an illustrative user profile page 160 according to various embodiments.

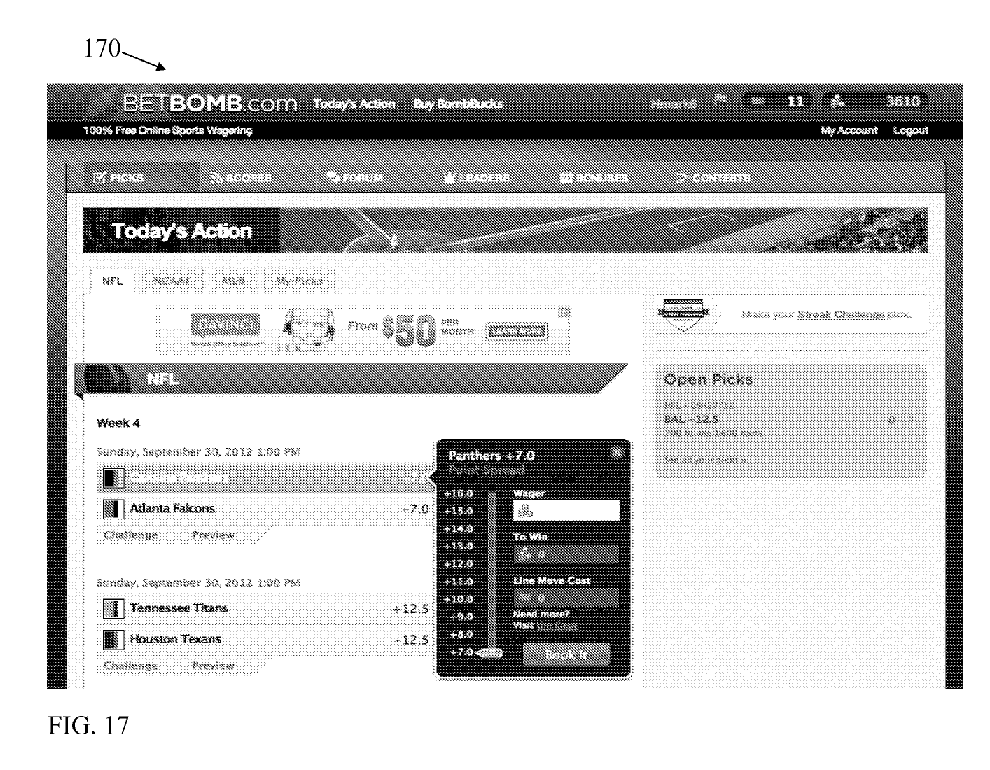

FIG. 17 shows an illustrative “picks” page 170 according to various embodiments.

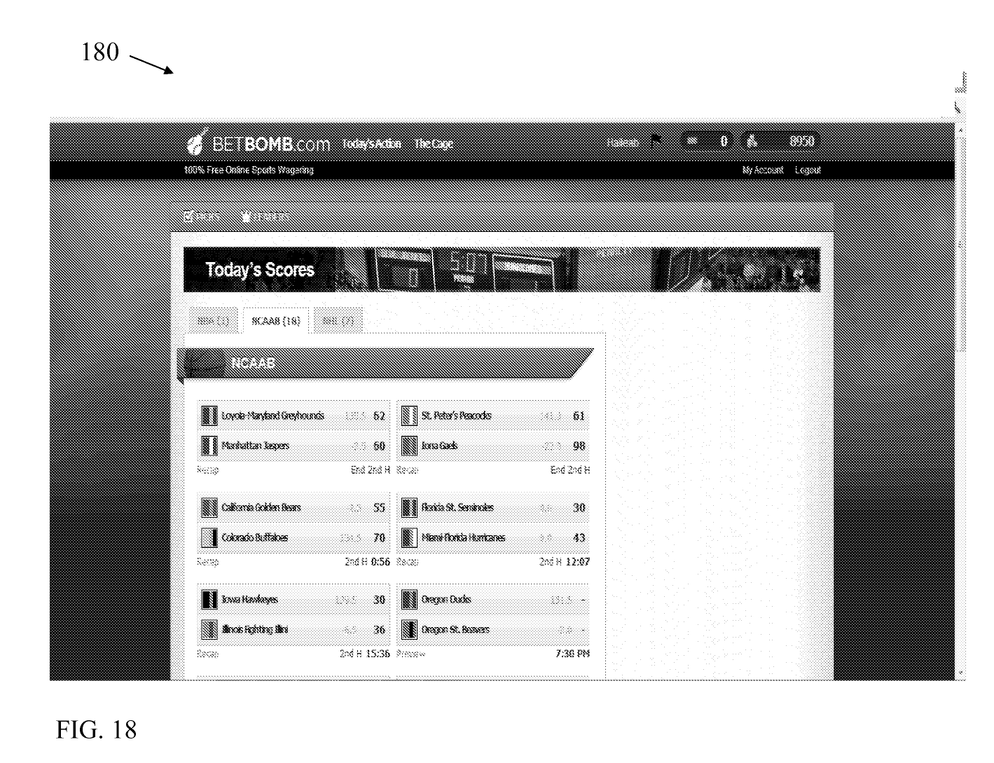

FIG. 18 shows an illustrative scores page 180 according to various embodiments.

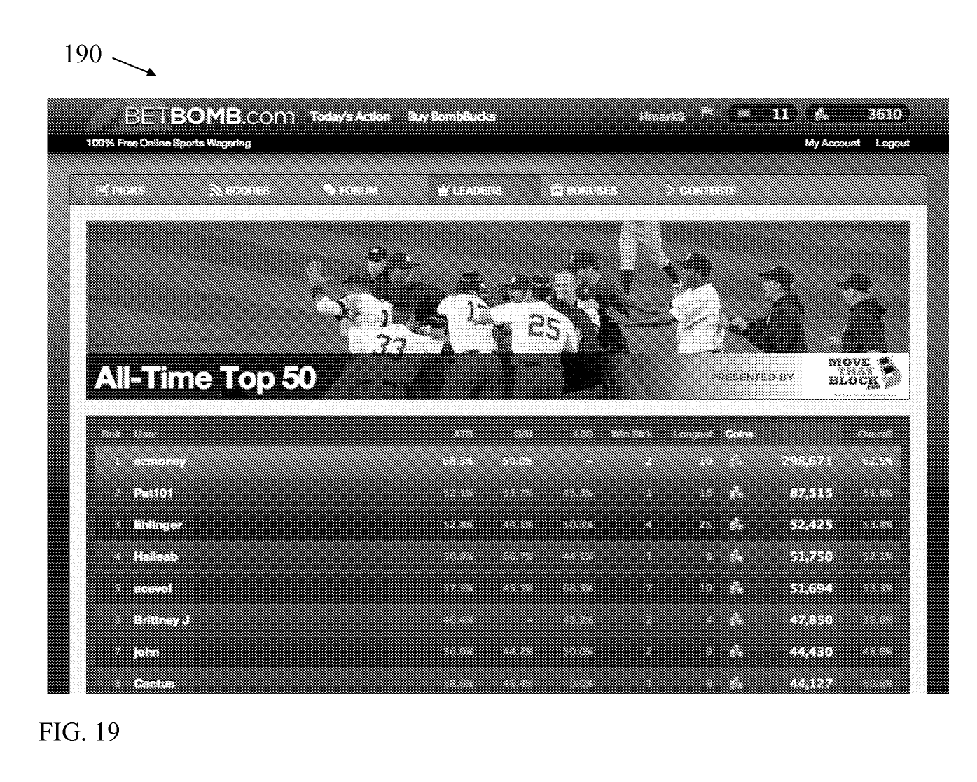

FIG. 19 shows an illustrative leaderboard page 190 according to various embodiments.

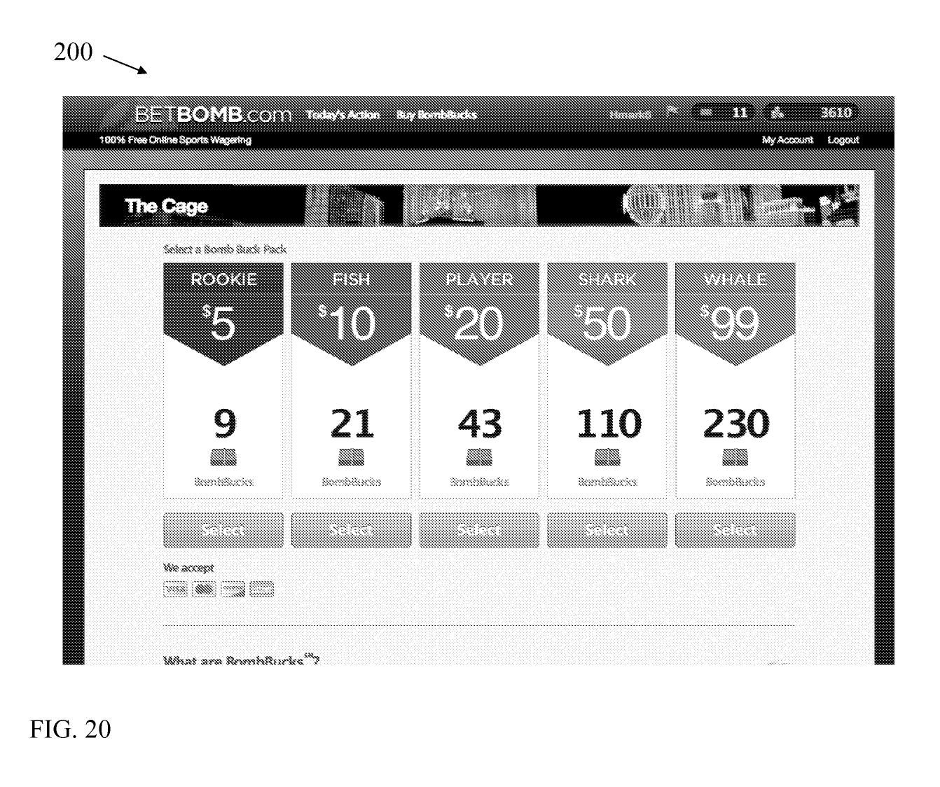

FIG. 20 shows an illustrative “cage” page 200 according to various embodiments.

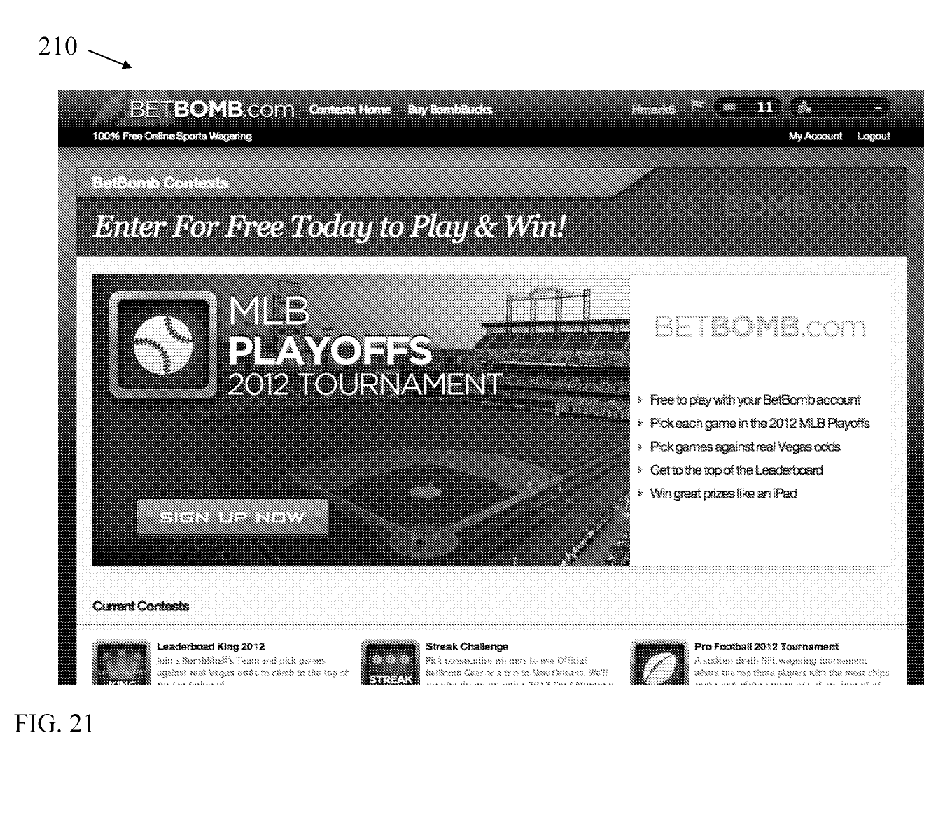

FIG. 21 shows an illustrative tournament signup page 210 according to various embodiments.

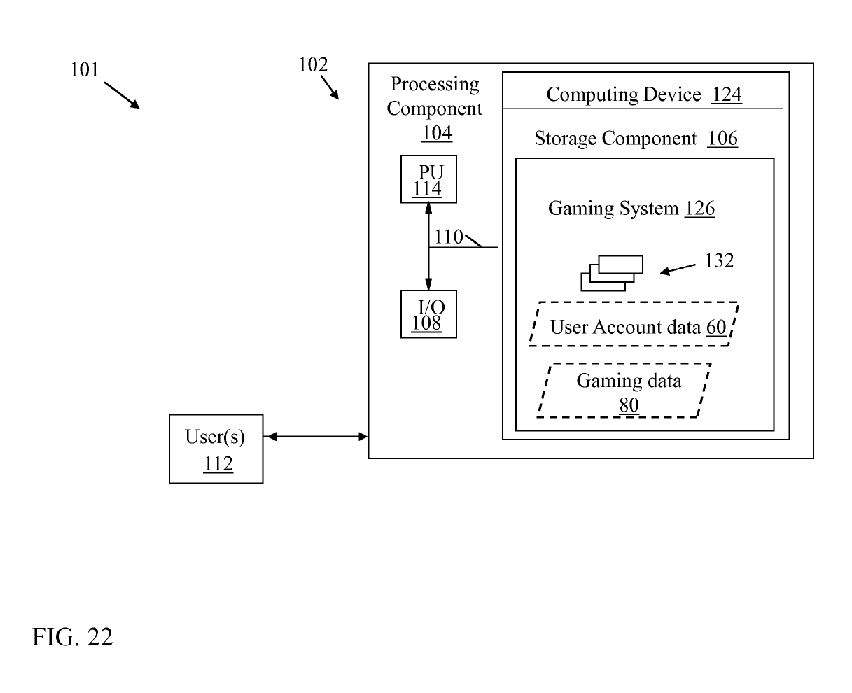

FIG. 22 shows an illustrative environment 101 including a gaming system 126, for performing the functions described herein according to various embodiments of the invention. To this extent, the environment 101 includes a computer system 102 that can perform one or more processes described herein in order to allow for one or more user(s) 112 to participate in gaming functions described herein. In particular, the computer system 102 is shown as including the gaming system 126, which makes computer system 102 operable to allow for one or more user(s) 112 to participate in gaming functions by performing any/all of the processes described herein and implementing any/all of the embodiments described herein.

The computer system 102 is shown including a computing device 124, which can include a processing component 104 (e.g., one or more processors), a storage component 106 (e.g., a storage hierarchy), an input/output (I/O) component 108 (e.g., one or more I/O interfaces and/or devices), and a communications pathway 110. In general, the processing component 104 executes program code, such as the gaming system 126, which is at least partially fixed in the storage component 106. While executing program code, the processing component 104 can process data, which can result in reading and/or writing transformed data from/to the storage component 106 and/or the I/O component 108 for further processing. The pathway 110 provides a communications link between each of the components in the computer system 102. The I/O component 108 can comprise one or more human I/O devices, which enable user(s) (e.g., a human and/or computerized user) 112 to interact with the computer system 102 and/or one or more communications devices to enable the system user(s) 112 to communicate with the computer system 102 using any type of communications link. To this extent, the gaming system 126 can manage a set of interfaces (e.g., graphical user interface(s), application program interface, etc.) that enable human and/or system users(s) 112 to interact with the gaming system 126. Further, the gaming system 126 can manage (e.g., store, retrieve, create, manipulate, organize, present, etc.) data, such as user account data 60 and/or gaming data 80 using any solution.

In any event, the computer system 102 can comprise one or more general purpose computing articles of manufacture (e.g., computing devices) capable of executing program code, such as the gaming system 126, installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, the gaming system 126 can be embodied as any combination of system software and/or application software. It is further understood that the gaming system 126 can be implemented in a cloud-based computing environment, where one or more processes are performed at distinct computing devices (e.g., a plurality of computing devices 24), where one or more of those distinct computing devices may contain only some of the components shown and described with respect to the computing device 124 of FIG. 4.

Further, the gaming system 126 can be implemented using a set of modules 132. In this case, a module 132 can enable the computer system 102 to perform a set of tasks used by the gaming system 126, and can be separately developed and/or implemented apart from other portions of the gaming system 126. As used herein, the term “component” means any configuration of hardware, with or without software, which implements the functionality described in conjunction therewith using any solution, while the term “module” means program code that enables the computer system 102 to implement the functionality described in conjunction therewith using any solution. When fixed in a storage component 106 of a computer system 102 that includes a processing component 104, a module is a substantial portion of a component that implements the functionality. Regardless, it is understood that two or more components, modules, and/or systems may share some/all of their respective hardware and/or software. Further, it is understood that some of the functionality discussed herein may not be implemented or additional functionality may be included as part of the computer system 102.

When the computer system 102 comprises multiple computing devices, each computing device may have only a portion of gaming system 126 fixed thereon (e.g., one or more modules 132). However, it is understood that the computer system 102 and gaming system 126 are only representative of various possible equivalent computer systems that may perform a process described herein. To this extent, in other embodiments, the functionality provided by the computer system 102 and gaming system 126 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 102 includes multiple computing devices 124, the computing devices can communicate over any type of communications link. Further, while performing a process described herein, the computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

The computer system 102 can obtain or provide data, such as user account data 60 and/or gaming data 80 using any solution. The computer system 102 can generate user account data 60 and/or gaming data 80, from one or more data stores, receive user account data 60 and/or gaming data 80, from another system, send image user account data 60 and/or gaming data 80 to another system, etc. As described herein, user account data 60 can include data about a user account, such as a points balance, dollar balance, bomb bucks balance, chips balance, history of performance using the gaming system 126, profile information, etc. Gaming data 80 can include information about one or more events, e.g., sporting events, such as parameters (e.g., odds-based parameters/predictions), schedules, locations, etc.

While shown and described herein as a method and system for providing a gaming system, it is understood that aspects of the invention further provide various alternative embodiments. For example, in one embodiment, the invention provides a computer program fixed in at least one computer-readable medium, which when executed, enables a computer system to provide a gaming system. To this extent, the computer-readable medium includes program code, such as the gaming system 126 (FIG. 22), which implements some or all of the processes and/or embodiments described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; etc.

In another embodiment, the invention provides a method of providing a copy of program code, such as the gaming system 126 (FIG. 22), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of providing a gaming system. In this case, a computer system, such as the computer system 102 (FIG. 22), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; etc.

In any case, the technical effect of the various embodiments of the invention, including, e.g., the gaming system 126, is to allow users to participate in gaming as described herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A gaming system comprising:
at least one computing device configured to perform the following:
permit users to register for a wagering account;
provide the registered users with credits in response to the registering;
allow the registered users to wager on events; and
allow users to modify a parameter of the event using accumulated parameter-modifying currency.

2. The gaming system of claim 1, wherein the events include sporting events.

3. The gaming system of claim 1, wherein the parameter of the event includes an odds-based parameter of the event.

4. The gaming system of claim 1, wherein the credits do not correspond to a monetary value.

5. The gaming system of claim 4, wherein the parameter-modifying currency corresponds to a monetary value.

6. The gaming system of claim 5, wherein the parameter-modifying currency is acquirable by exchanging the monetary value for the parameter-modifying currency via the wagering account.

7. The gaming system of claim 5, wherein the parameter of the event includes an odds-based parameter of the event, and wherein the modifying of the parameter of the event using the accumulated parameter-modifying currency increases a likelihood that one of the users will win a wager on the event.

8. A gaming system comprising:
at least one computing device configured to perform the following:
permit a user to register for a wagering account;
provide the registered user with at least one credit in response to the registering;
permit the user to register for a wagering tournament including a plurality of events;
allow the registered user to wager on an event in the plurality of events, the user competing against at least one other user in the wagering tournament; and
allow the user to modify a parameter of the event in the plurality of events using accumulated parameter-modifying currency.

9. The gaming system of claim 8, wherein the plurality of events include sporting events.

10. The gaming system of claim 8, wherein the parameter of the event includes an odds-based parameter of the event.

11. The gaming system of claim 8, wherein the at least one credit does not correspond to a monetary value.

12. The gaming system of claim 11, wherein the parameter-modifying currency corresponds to a monetary value.

13. The gaming system of claim 12, wherein the parameter-modifying currency is acquirable by exchanging the monetary value for the parameter-modifying currency via the wagering account.

14. The gaming system of claim 13, wherein the parameter of the event includes an odds-based parameter of the event, and wherein the modifying of the parameter of the event using the accumulated parameter-modifying currency increases a likelihood that the user will win a wager on the event against the at least one other user.

15. The gaming system of claim 8, wherein, in response to the user registering for the wagering tournament, the at least one computing device further performs the following:
provides the user with a set of chips for use in wagering on at least one event in the plurality of events;
provides the user with at least one new chip in response to winning a wager on a first event in the plurality of events in the wagering tournament,
provides the user with at least one additional new chip in response to winning a subsequent wager on a second event in the plurality of events in the wagering tournament; and
identifies the user as a winner of the wagering tournament in response to the user possessing more chips than all other users participating in the wagering tournament at a conclusion of the wagering tournament.

16. A gaming system comprising:
at least one computing device configured to perform the following:
permit a user to register for a wagering account;
provide the registered user with at least one credit in response to the registering;
permit the user to register for a wagering tournament including a plurality of successively occurring sporting events;
allow the registered user to wager on a sporting event in the plurality of successively occurring sporting events, the user competing against at least one other user in the wagering tournament; and
allow the user to modify a predetermined odds-based prediction of an outcome of the sporting event in the plurality of successively occurring sporting events using accumulated parameter-modifying currency.

17. The gaming system of claim 16, wherein the user is invited to register for the wagering tournament based upon performance by the user in wagering on previously occurring sporting events using the wagering account.

18. The gaming system of claim 16, wherein the user is permitted to register for the wagering tournament in exchange for the user purchasing a right of entry to the wagering tournament.
